(19) United States
(12) Patent Application Publication
(10) Pub. No.: US 2026/0188882 A1
(43) Pub. Date: Jul. 2, 2026

(54) WAVEGUIDE PHASE SHIFTER

(71) Applicant: ELECTRONICS AND TELECOMMUNICATIONS RESEARCH INSTITUTE, Daejeon (KR)

(72) Inventor: Hak Min LEE, Daejeon (KR)

(21) Appl. No.: 19/392,490

(22) Filed: Nov. 18, 2025

(30) Foreign Application Priority Data
Dec. 26, 2024 (KR) 10-2024-0196824

(51) Int. Cl. H01P 1/18; H01Q 3/32

(52) U.S. Cl. CPC H01P 1/182; H01Q 3/32

(57) ABSTRACT

An aspect of the disclosure is a waveguide, comprising: a housing comprising an internal accommodating space; the waveguide inlet disposed on one side of the housing in the longitudinal direction; and the waveguide outlet disposed on the other side of the housing in the longitudinal direction, wherein the housing comprises: a first plate disposed on one side in a height direction perpendicular to the longitudinal direction; a second plate disposed on the other side in the height direction; and a pair of third plates connecting the first plate and the second plate in the height direction and spaced apart from each other in a transverse direction perpendicular to the longitudinal direction and the height direction, wherein a plurality of first pins disposed on the first plate and a plurality of second pins disposed on the second plate are spaced apart from each other in the height direction.

### CROSS-REFERENCE TO RELATED APPLICATION

The present application is based on, and claims priority from, Korean Patent Application No. 10-2024-0196824, filed on Dec. 26, 2024, the entire contents of which are hereby incorporated herein by reference.

### TECHNICAL FIELD

The disclosure relates to waveguide phase shifter. More particularly, the disclosure relates to a waveguide phase shifter that adjusts an internal structure of a waveguide used in a wireless communication system to precisely control a phase of a signal.

### BACKGROUND

The content described below merely provides background information related to the embodiments of the disclosure, and does not constitute the related art.

A waveguide phase shifter is an important component of radar and wireless communication systems, and play a pivotal role within the high throughput satellites (HTS) architecture. An antenna system of HTS, which represents the next-generation satellite communications, mainly utilizes multi feed. The multi feed per beam (MFPB) method involves transmitting a plurality of signals using a single horn by connecting various feeders. MFPB method has various configurations depending on beam coverage. To meet the requirements of various beam coverage, an adjustable signal phase and magnitude at each feeder output are required. A feeder network connected to a horn array is commonly known as a beamforming network (BFN), and complexity of signals is caused by irregular excitation coefficients. The excitation coefficient needs to be customized according to a range and geographical requirements of a particular beam. Therefore, a customized phase shifter and a 1×N non-uniform power divider are required.

Since the antennas and BFNs are the bulkiest components in a communication system, there is a transition to using additive manufacturing (AM), especially metal 3D printing, to reduce both manufacturing costs and weights of the components. Therefore, there is a need for a BFN design that facilitates additive manufacturing and ensure both simplified design and reduced volume.

In order to implement BFN design, methods of adjusting a phase of a signal are being considered. The simplest method of adjusting the phase of the signal is to increase a length of a waveguide at a desired output port. However, the method of increasing the length of the waveguide not only enlarges the size of the beamforming network (BFN), but also fails to control a phase slope that varies with the length of the waveguide, thereby increasing a risk of phase mismatch within a required frequency band.

Another method is to set a required phase simultaneously while designing 1 xN unequal power divider. Although this may reduce the size of the BFN, it may not be easy to logically design the BFN because new excitation coefficients required for other beam coverages need to be considered. Therefore, a simulation-based approach is needed.

Finally, other method is to adjust a phase required for the excitation coefficient by inserting a dielectric into the waveguide or by using a ridge or gap pin structure in the waveguide. However, inserting the dielectric into the waveguide or using the ridge or gap pin structure in the waveguide results in a size that is too large to be efficient for satellite communications and causes significant loss in the waveguide phase shifter. Furthermore, it is not suitable for the MFPB antenna market to which the additive manufacturing technology is applied. Therefore, there is a need for a waveguide phase shifter that is small and may adjust the phase in a wide range, has a constant slope of each phase within an operating frequency range, and is compatible with the additive manufacturing process.

### SUMMARY

The disclosure is primarily directed to precisely adjust a propagation constant by using a mode change according to a direction of an electromagnetic field inside a waveguide.

The disclosure is primarily directed to adjust a phase from 0 degrees to 180 degrees by changing a physical structure inside the waveguide, so as to maintain a similar slope in all phases and reduce the size and complexity of the BFN, thereby improving economic efficiency.

The problems to be solved by the disclosure are not limited to the problems mentioned above, and other problems not mentioned will be clearly understood by those skilled in the art from the following description.

An aspect of the disclosure is a waveguide, comprising: a housing comprising an internal accommodating space; the waveguide inlet disposed on one side of the housing in the longitudinal direction; and the waveguide outlet disposed on the other side of the housing in the longitudinal direction, wherein the housing comprises: a first plate disposed on one side in a height direction perpendicular to the longitudinal direction; a second plate disposed on the other side in the height direction; and a pair of third plates connecting the first plate and the second plate in the height direction and spaced apart from each other in a transverse direction perpendicular to the longitudinal direction and the height direction, wherein a plurality of first pins disposed on the first plate and a plurality of second pins disposed on the second plate are spaced apart from each other in the height direction.

Another aspect of the disclosure is a method for designing a waveguide, performed by an electronic device comprising a processor and a memory, the method comprising: adjusting a size of a plurality of first pins spaced apart from each other on a first plate disposed on one side in a height direction perpendicular to a longitudinal direction; and adjusting a size of a plurality of second pins spaced apart from each other on a second plate disposed on the other side in the height direction.

According to an embodiment of the disclosure, the performance of a radar or a wireless communication system can be optimized by enabling precise phase adjustment and impedance matching.

According to an embodiment of the disclosure, production efficiency can be maximized by providing an economical waveguide fabrication method utilizing additive manufacturing.

According to an embodiment of the disclosure, design flexibility of waveguide can be provided to flexibly respond to various beam coverage requirements.

The effects of the present disclosure are not limited to the effects mentioned above, and other effects not mentioned will be clearly understood by those skilled in the art from the following description.

### BRIEF DESCRIPTION OF DRAWINGS

FIG. 1 is an exemplary perspective view of a waveguide according to an embodiment of the disclosure.

FIGS. 2A and 2B are each a cross-sectional view of the waveguide as viewed in a longitudinal direction and a height direction.

FIGS. 3A, 3B, 3C, and 3D are each a graph showing changes in phase and reflection loss for parameter according to an embodiment of the disclosure.

FIGS. 4A, 4B, 4C, and 4D are each a graph showing changes in phase and reflection loss for W₁ or W₂ parameter according to an embodiment of the disclosure.

FIGS. 5A, 5B, 5C, and 5D are each a graph showing changes in phase and reflection loss for L₁ or L₂ parameter according to an embodiment of the disclosure.

FIGS. 6A, 6B, 6C, and 6D are each a graph showing changes in phase and reflection loss for D₁ or D₄ parameter according to an embodiment of the disclosure.

FIGS. 7A and 7B are each a diagram illustrating electric field distributions for respective phases according to an embodiment of the disclosure.

FIG. 8 is a diagram illustrating a numerical table of parameters for respective phases according to an embodiment of the disclosure.

FIGS. 9A and 9B are each a diagram illustrating a case where a plurality of pins are diagonalized in an existing design structure according to an embodiment of the disclosure.

FIGS. 10A and 10B are each a diagram illustrating a waveguide fabricated by an additive manufacturing technique according to an embodiment of the disclosure and a waveguide of the disclosure.

FIGS. 11A and 11B are each a diagram illustrating simulation results of a phase shift from 0 degrees to 180 degrees and reflection coefficients for respective phases according to an embodiment of the disclosure.

FIG. 12 is a block diagram schematically illustrating an example computing device that may be used to implement a method or apparatus according to the disclosure.

### DETAILED DESCRIPTION

Hereinafter, some embodiments of the disclosure will be described in detail with reference to illustrative drawings. It should be noted that, in adding reference numerals to the components in each drawing, the same reference numerals are used for the same components as much as possible, even if they are shown in different drawings. In addition, in describing the disclosure, when it is determined that a specific description of a related known configuration or function may obscure the gist of the disclosure, a detailed description thereof will be omitted.

In describing the components of the embodiments according to the disclosure, reference numerals such as first, second, i), ii), a), and b) may be used. These numerals are merely used to distinguish one component from another component, and do not limit the nature, order, sequence, or the like of that components by such numerals. In the specification, when a part is described as “comprising” or “including” a certain component, it means that other components may be further included instead of excluding other components unless explicitly stated to the contrary.

The detailed description set forth below in conjunction with the appended drawings is intended to describe exemplary embodiments of the disclosure and is not intended to represent the only embodiments in which the disclosure may be practiced.

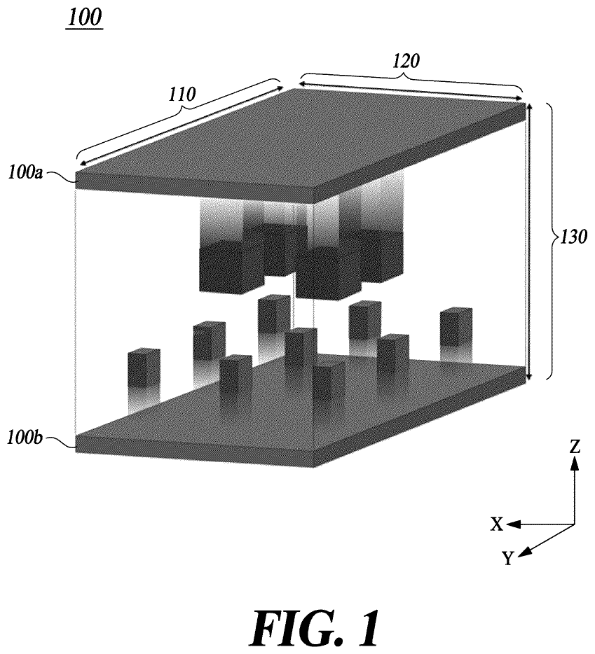

FIG. 1 is an exemplary perspective view of a waveguide 100 according to an embodiment of the disclosure.

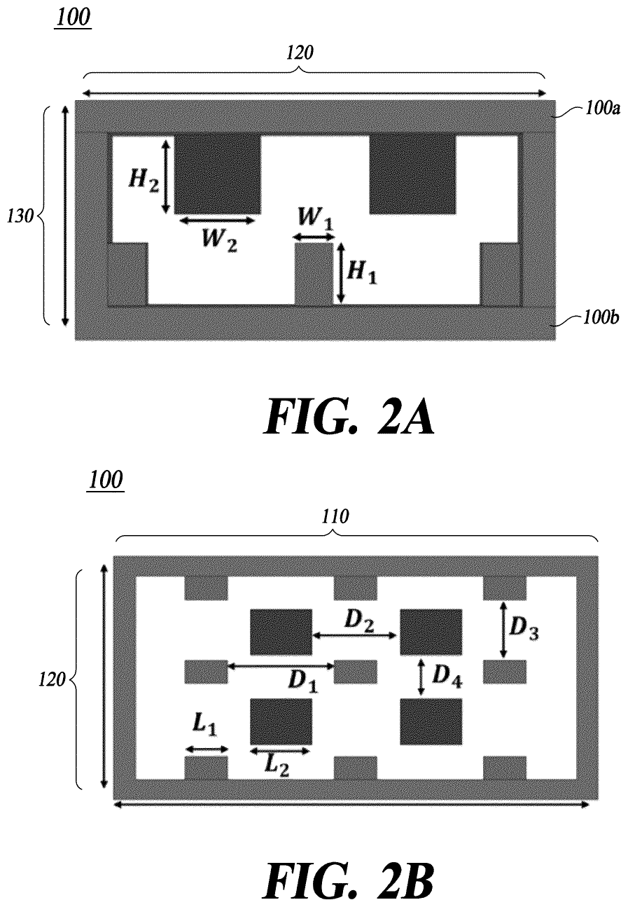

The waveguide 100 includes a plurality of plates. As shown in FIG. 1, the waveguide 100 may comprise a housing comprising internal an accommodating space. A waveguide inlet may be disposed on one side of the housing in the longitudinal direction 110, and a waveguide outlet may be disposed on the other side of the housing in the longitudinal direction 110. An opening of the waveguide inlets may have a shape of a rectangular cross-section, but is not limited thereto. A length of one side in the longitudinal direction 110 of the waveguiding 100 is 1.35λₒ, but is not limited thereto. λₒ is a free space wavelength, which will be described in FIGS. 2A and 2B. The waveguide 100 is symmetric about a horizontal axis bisecting the waveguide 100. Specifically, a structure of the housing may have a rectangular shape, but is not limited thereto.

Referring to the structure of the waveguide 100, the waveguide 100 includes a first plate 100a, a second plate 100b, and third plates. The first plate 100a is disposed on one side in a height direction 130 perpendicular to the longitudinal direction 110 of the housing. The second plate 100b is disposed on the other side in the height direction 130. A pair of third plates connect the first plate 100a and the second plate 100b in the height direction 130, and are spaced apart from each other in a transverse direction 120 perpendicular to the longitudinal direction 110 and the height direction 130.

A plurality of first pins are disposed on the first plate 100a. A plurality of second pins are disposed on the second plate 100b. That is, four pins are disposed on the first plate 100a, and nine pins are disposed on the second plate 100b. The plurality of first pins and the plurality of second pins are spaced apart from each other in the height direction 130. When viewed in the height direction 130 of the waveguide 100, the plurality of first pins and the plurality of second pins do not overlap with each other. A size of the cross-sectional area of the plurality of first pins is greater than a size of a cross-sectional area of the plurality of second pins. The plurality of the first pins each have the same diameter. The plurality of second pins each have the same diameter.

FIGS. 2A and 2B are each a cross-sectional view of the waveguide 100 as viewed in a longitudinal direction and a height direction. To describe FIGS. 2A and 2B, reference may be made to FIG. 1 together.

FIG. 2A illustrates a cross-section viewed from one side in the longitudinal direction 110. FIG. 2B illustrates a cross-section viewed from one side in the height direction 130.

Referring to FIGS. 2A and 2B, there are a plurality of first pins and a plurality of second pins inside the waveguide 100. The sizes and spacings of the plurality of first pins and the plurality of second pins are defined by different parameters D₁, D₂, D₃, D₄, H₁, H₂, L₁, L₂, W₁, W₂. By adjusting the sizes and the spacings of the plurality of pins disposed on the first plate 100a and the second plate 100b of the waveguide 100, impedance matching and phase difference may be precisely controlled. Herein, the impedance matching refers to matching an input impedance and an output impedance of the waveguide by adjusting an internal structure of the waveguide. By adjusting the sizes and the spacings of the plurality of pins, the waveguide 100 may also be designed to have a shorter length. The disclosure relates to an improvement in the phase constant β in the waveguide 100, and is designed to precisely control a phase change experienced by a wave as it passes through the waveguide 100. The phase constant depends on a physical structure of the waveguide 100 and the properties of the electromagnetic wave and is defined as in Equation 1:

$$β = \frac{2 π}{{λ}_{g}} \qquad [ Equation 1 ]$$

Wherein, λ_{g} is a guide wavelength in the waveguide 100. The guide wavelength λ_{g} varies depending on the free space wavelength λₒ and an operating mode of the waveguide.

The guide wavelength λ_{g} is defined as in Equation 2.

$${λ}_{g} = \frac{{λ}_{o}}{\sqrt{1 - {( \frac{{λ}_{o}}{{λ}_{c}} )}^{2}}} \qquad [ Equation 2 ]$$

Wherein, λ_{c} is a cutoff wavelength, and is determined based on the dimension and the operation mode of the waveguide 100. The cutoff wavelength λ_{c} is calculated according to Equation 3.

$${λ}_{c} = \frac{2 a}{\sqrt{{m}^{2} + {n}^{2}}} \qquad [ Equation 3 ]$$

Wherein, a denotes a length in the transverse direction 120 of the first plate 100a or the second plate 100b of the waveguide 100. m and n are integers indicating a transverse electric (TE) mode or a transverse magnetic (TM) mode of the waveguide 100. For example, in the case of the TE10 mode, m=1 and n=0. In the case of the TM10 mode, m=0 and n=1. Parameters according to the sizes and spacings of the plurality of pins disposed inside the waveguide 100 affect propagation characteristics of the waveguide 100, such as impedance matching and phase shifting. By adjusting these parameters, desired performance may be implemented in a specific frequency band. Therefore, it is possible to precisely control a phase and a phase slope within the specific frequency band.

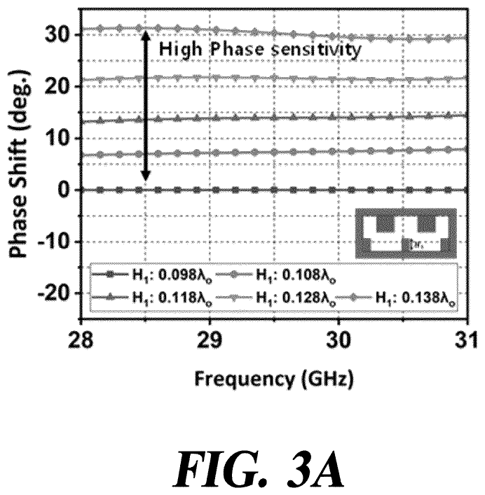

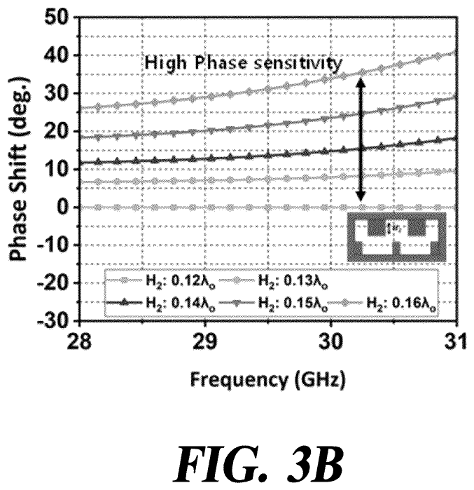

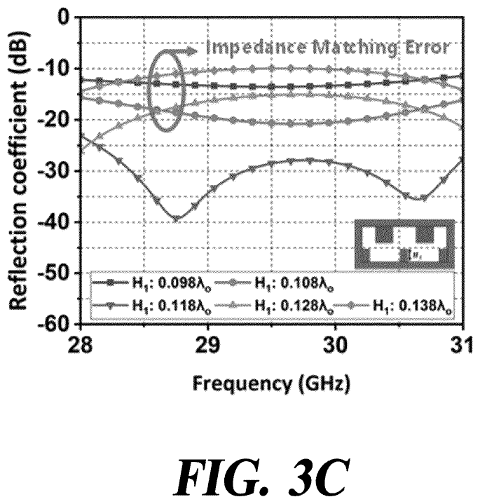

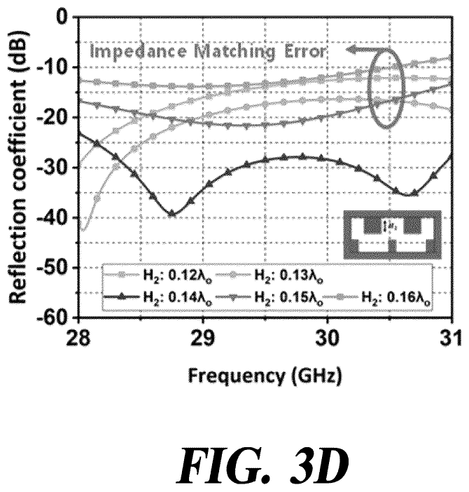

FIGS. 3A, 3B, 3C, and 3D are each a graph showing changes in phase and reflection loss for parameter according to an embodiment of the disclosure. To describe FIGS. 3A-3D, reference may be made to FIGS. 1 and 2A together.

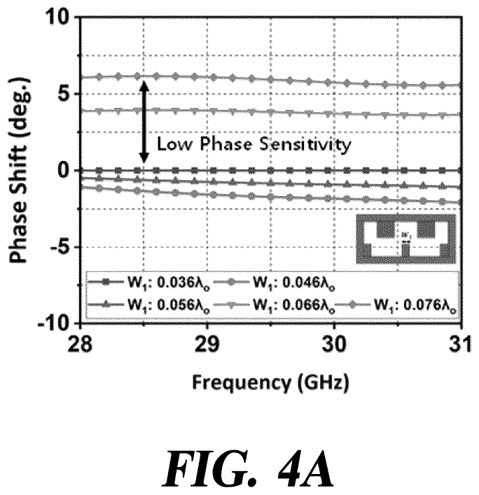

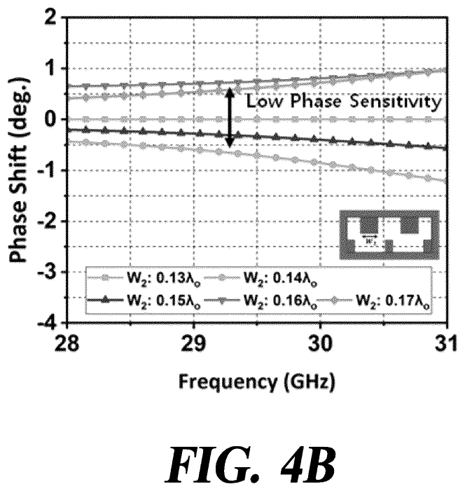

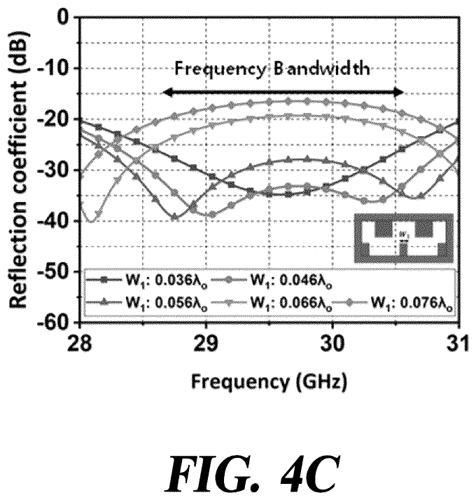

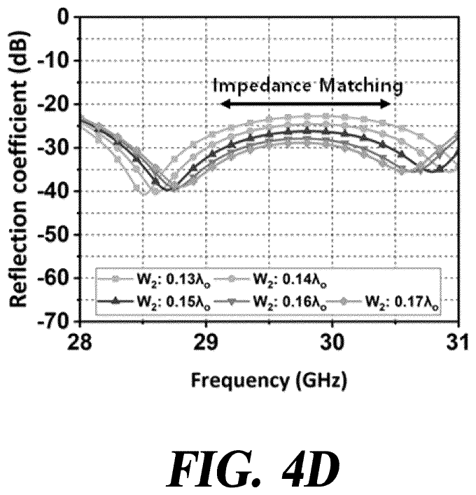

H₁ and H₂ refer to the heights of the pins disposed on the first plate 100a and the second plate 100b, respectively. When the height of the pins inside the waveguide 100 is increased, it becomes an obstacle in terms of propagation wave. For example, when the height of the pin is increased, the path of the propagation wave becomes physically longer, and the phase value may be changed. That is, from the perspective of the propagation wave, it has a similar meaning to that of the length of the waveguide being increased. When the length of the waveguide is increased, the phase value tends to be relatively low. Therefore, when the heights of pins are increased, the relative phase value becomes lower. Accordingly, when the sizes of H₁ and H₂ increase in increments of nλₒ, a change width of the relative phase shift is also the largest, with a minimum of 8.0 degrees or more. On the other hand, referring to FIGS. 3C and 3D, the performance of the reflection coefficient deteriorates. The reason for the deterioration in the performance of the reflection coefficient is that good impedance matching does not occur because the propagation wave is disturbed in the direction of progress. When a graph is formed at −20 dB or below on the y-axis of the graphs of FIGS. 3C and 3D, it may be considered that impedance matching effectively occurs. The disclosure proposes a method of simultaneously optimizing the phase and reflection coefficient performance within a specific frequency band by adjusting not only the height of the pins but also other structural parameters of the waveguide 100. Therefore, in the following FIGS. 4A-7B present parameter analyses within a desired frequency band while maintaining the changed phase by adjusting sizes and spacings of a plurality of pins in the internal structure of the proposed waveguide 100.

FIGS. 4A, 4B, 4C, and 4D are each a graph showing changes in phase and reflection loss for W₁ or W₂ parameter according to an embodiment of the disclosure. To describe FIGS. 4A-4D, reference may be made to FIGS. 1 and 2A together.

W₁ and W₂ refer to the widths of the pins disposed on the first plate 100a and the second plate 100b, respectively. When the sizes of the W₁ and W₂ increase in increments of nλₒ, the relative phase shift width is up to 3.0 degrees. That is, it may be seen that when W₁ and W₂ are adjusted, the sensitivity of the phase change is low. In other words, W₁ and W₂ have a slight effect on the phase change. On the other hand, referring to FIGS. 4C and 4D, it may be seen that when the sizes of the W₁ and W₂ increase in increments of nλₒ, the frequency bandwidth increases. Accordingly, as the sizes of the pins inside the waveguide 100 vary, the resonant frequency shifts, and impedance matching may be effectively performed in a desired frequency band by utilizing the W₁ and W₂ parameters.

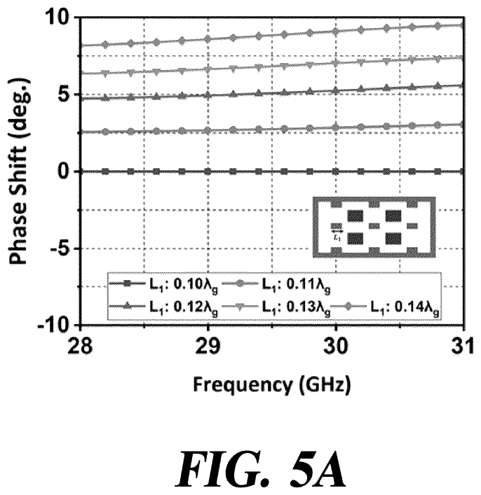

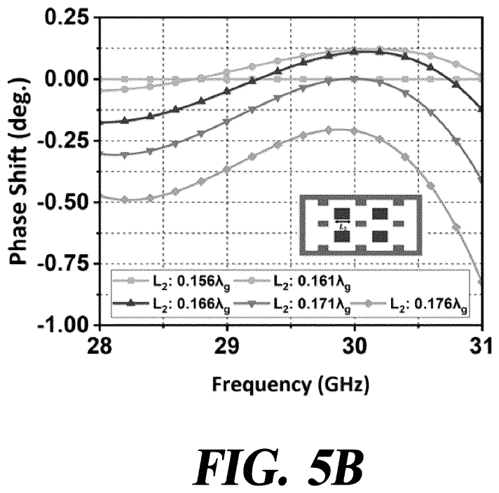

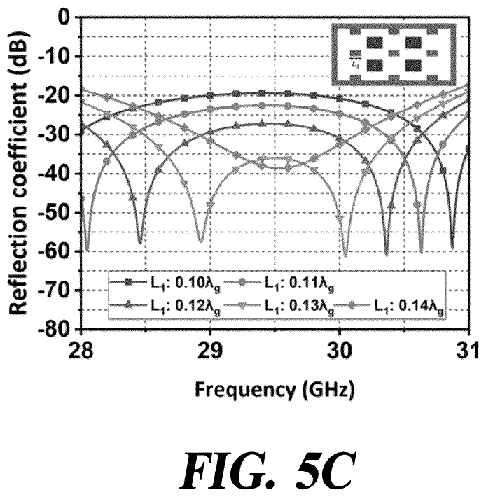

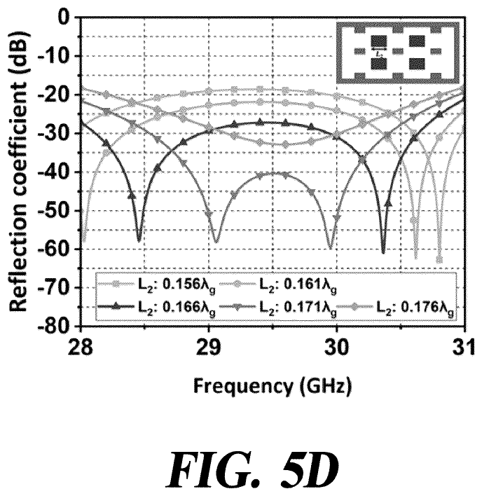

FIGS. 5A, 5B, 5C, and 5D are each a graph showing changes in phase and reflection loss for L₁ or L₂ parameter according to an embodiment of the disclosure. To describe FIGS. 5A-5D, reference may be made to FIGS. 1 and 2B together.

L₁ and L₂ refer to the lengths of the pins disposed on the first plate 100a and the second plate 100b, respectively. When the sizes of L₁ and L₂ increase in increments of nλₒ, the relative phase shift width is up to 3.0 degrees. That is, it may be seen that when L₁ and L₂ are adjusted, the sensitivity of the phase change is low. In other words, L₁ and L₁ have a slight effect on the phase change. On the other hand, referring to FIGS. 4C and 4D, it may be seen that when the sizes of the L₁ and L₂ increase in increments of nλₒ, the frequency bandwidth increases. Accordingly, as the sizes of the pins inside the waveguide 100 vary, the resonant frequency shifts, and impedance matching may be effectively performed in a desired frequency band by utilizing the L₁ and L₂ parameters.

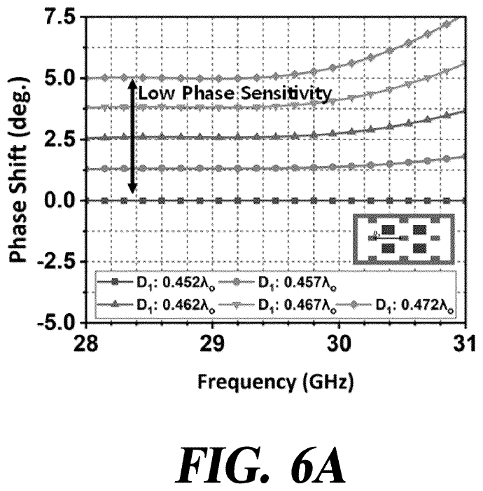

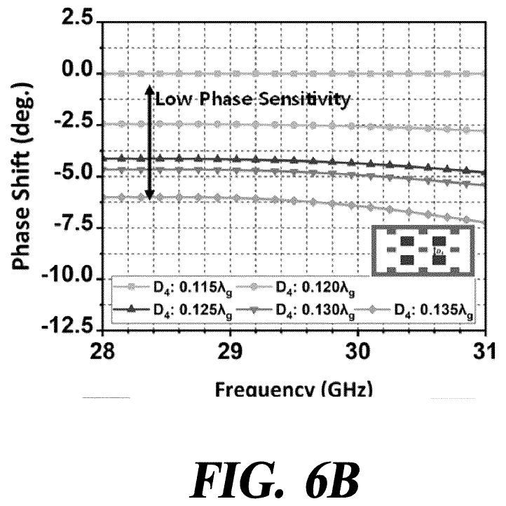

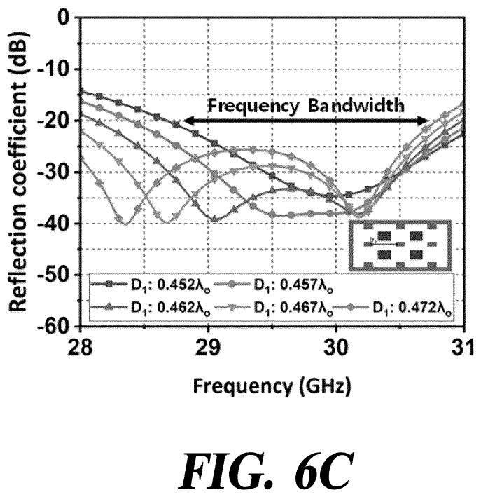

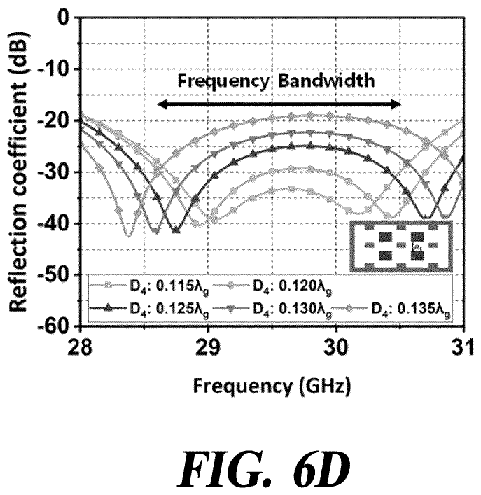

FIGS. 6A, 6B, 6C, and 6D are each a graph showing changes in phase and reflection loss for D₁ or D₄ parameter according to an embodiment of the disclosure. To describe FIGS. 6A-6D, reference may be made to FIGS. 1 and 2B together.

D₁ and D₄ refer to the spacing of the pins disposed on the second plate 100b and the first plate 100a, respectively. That is, D₁ refers to the shortest distance between pins disposed on the second plate 100b based on the longitudinal direction 110. D₄ refers to the shortest distance between pins disposed on the first plate 100a based on the transverse direction 120. When the D₁ and D₄ parameters increase in increments of nλₒ, the relative phase shift width is up to 2.5 degrees. That is, it may be seen that when D₁ and D₄ are adjusted, the sensitivity of the phase change is low. On the other hand, referring to FIGS. 6C and 6D, it may be confirmed that in the case of D₁, when it increases in increments of nλₒ, multiple resonance occurs, and the resonance frequencies other than the center frequency tend to shift to the left. That is, as the spacing of the pins disposed on the first plate 100a and the second plate 100b varies, the mode inside the waveguide 100 is changed, thereby affecting the impedance. Accordingly, impedance matching in a desired band may be performed using the D₁ and D₄ parameters.

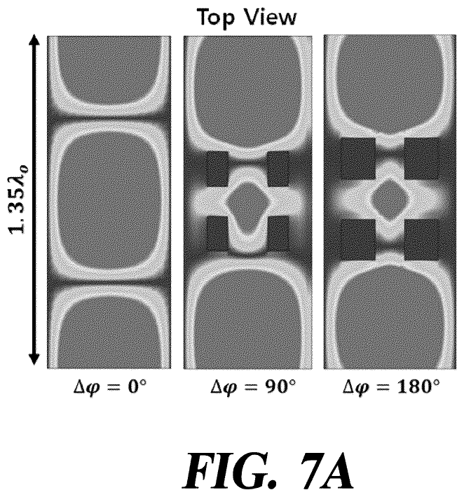

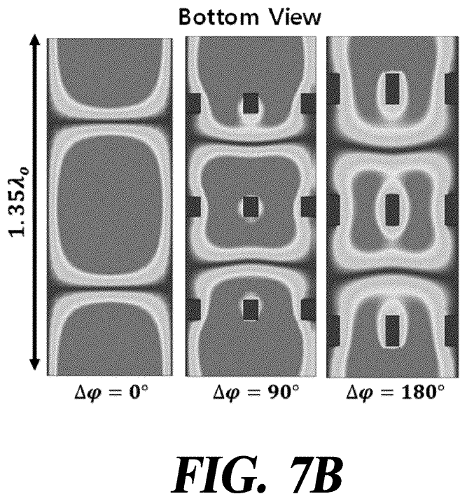

FIGS. 7A and 7B are each a diagram illustrating electric field distributions for respective phases according to an embodiment of the disclosure. To describe FIGS. 7A and 7B, reference may be made to FIG. 1 together.

FIG. 7A is a top view of the proposed invention. FIG. 7B is a bottom view of the proposed disclosure. Referring to FIGS. 7A and 7B, it may be confirmed that a mode change occurs as an electric field passes through the internal structure of the waveguide 100, due to changes in the sizes and spacings of the pins disposed on the first plate 100a and the second plate 100b.

It may be confirmed that as m and n change while passing through the internal structure of the waveguide 100, and the value of the cutoff wavelength changes, thereby affecting a phase constant β. Therefore, it is demonstrated that a desired phase value may be adjusted by adjusting the sizes and spacings of the pins disposed on the first plate 100a and the second plate 100b. Here, m and n are integers indicating the TE mode or the TM mode of the waveguide 100.

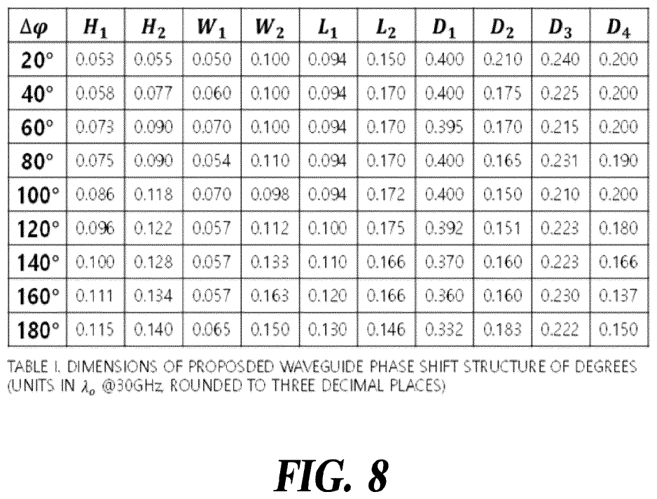

FIG. 8 is a diagram illustrating a numerical table of parameters for respective phases according to an embodiment of the disclosure. To describe FIG. 8, reference may be made to FIGS. 1 and 2B together.

Sizes and spacings of the plurality of first pins and the plurality of second pins are defined by different parameters D₁, D₂, D₃, D₄, H₁, H₂, L₁, L₂, W₁, W₂. The numerical values in FIG. 8 are based on the free space wavelength λₒ. Here, the length A in the transverse direction 120 of the waveguide is 6.3 mm. The length B in the height direction 130 of the waveguide is 2.65 mm.

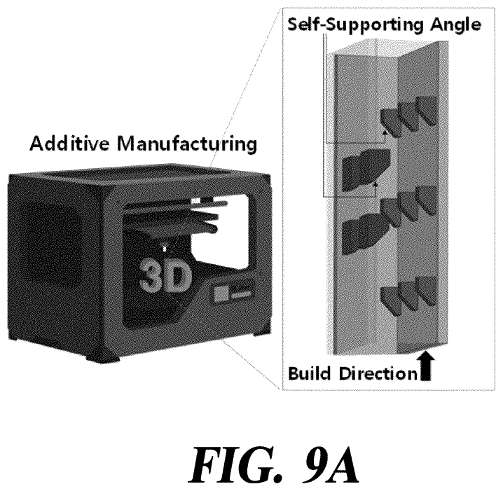

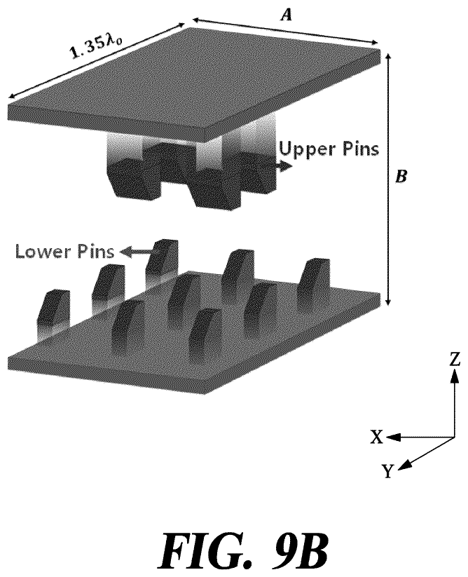

FIGS. 9A and 9B are each a diagram illustrating a case where a plurality of pins are diagonalized in an existing design structure according to an embodiment of the disclosure. To describe FIGS. 9A and 9B, reference may be made to FIG. 1 together.

FIGS. 9A and 9B are each diagram illustrating a modified design applied to an existing structure in order to prevent an overhang structure that may occur in an additive manufacturing process. The overhang structure refers to a state in which a specific component exists without being supported by an already hardened material or substrate during fabrication. The overhang structure not only degrades structural stability during fabrication, but also negatively affect fabrication accuracy. In order to solve problems caused by the overhang structure, the disclosure may additionally apply a self-supporting angle design of pins. When viewed from one side in the transverse direction 120 of the waveguide 100, a cross-sectional shape of each of the plurality of first pins may be configured such that one side in the longitudinal direction 110 of one end in the height direction 130 is inclined toward the first plate. When viewed from one side in the transverse direction 120 of the waveguide 100, a cross-sectional shape of each of the plurality of second pins may be configured such that one side in the longitudinal direction 110 of one end in the height direction 130 is inclined toward the second plate. That is, in a fabrication process in which surfaces of the plurality of pins are inclined at a certain angle, a component may be supported by itself, thereby greatly improving structural stability during fabrication and increasing precision of a final fabricated product.

In particular, by optimizing the spacing and design angle of the plurality of pins of the first plate 100a and the second plate 100b, it is possible to improve the structural stability and improve the efficiency of additive manufacturing. The disclosure presents an innovative approach capable of overcoming limitations of additive manufacturing technology and enabling fabrication of high-precision and high-stability components.

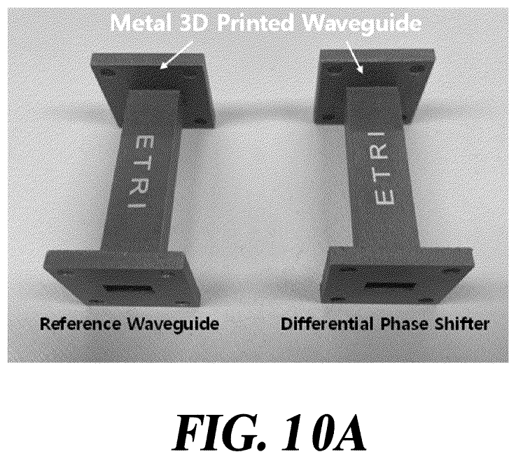

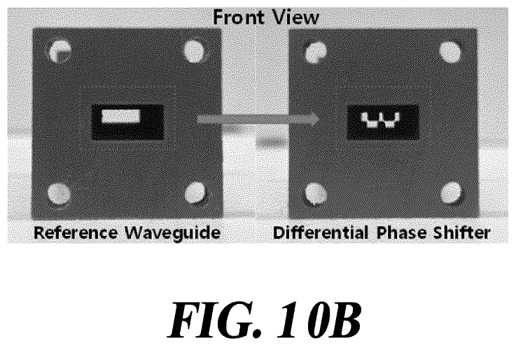

FIGS. 10A and 10B are each a diagram illustrating a waveguide fabricated by an additive manufacturing technique according to an embodiment of the disclosure and a waveguide 100 of the disclosure.

FIG. 10A illustrates the overall structures of a waveguide widely used in the past (left) and a waveguide of the disclosure (right). Both waveguides were fabricated using a metal additive manufacturing process. FIG. 10B is a diagram comparing internal structures of the two waveguides by enlarging front views of the inlets of both waveguide. The waveguide 100 on the right has a plurality of pins inserted therein, and the phase conversion function may be implemented in a specific frequency band by converting the internal structure. Accordingly, it shows the precision of the fabrication technology due to the structural difference, and at the same time, it suggests that the design of the disclosure may provide differentiated performance compared to the existing waveguide.

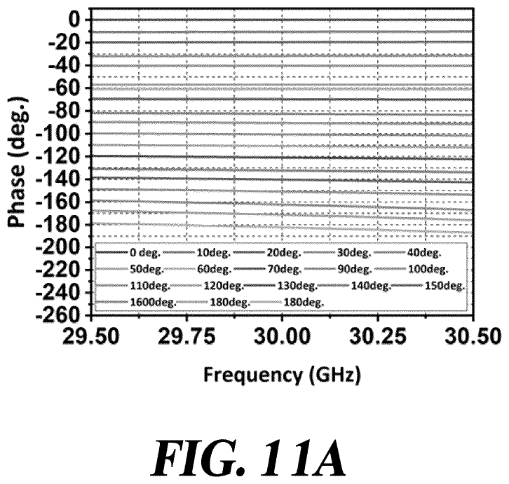

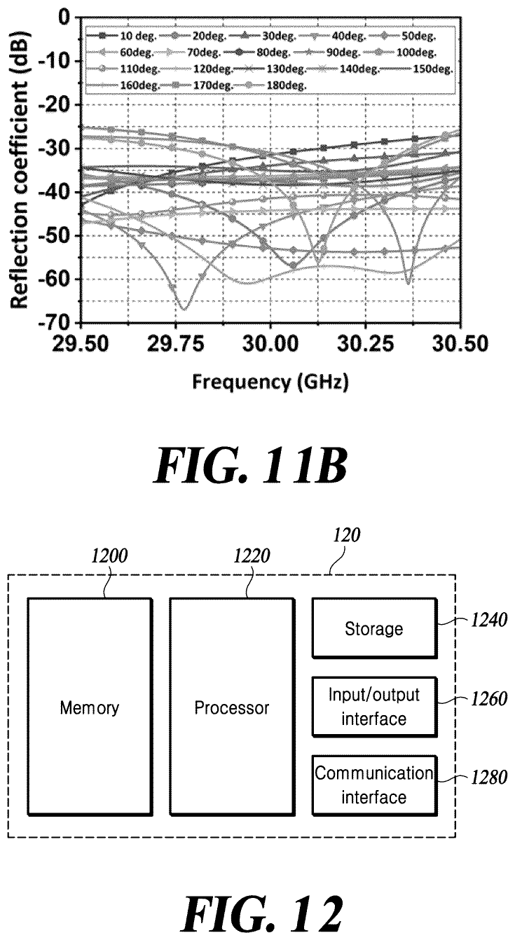

FIGS. 11A and 11B are each a diagram illustrating simulation results of a phase shift from 0 degrees to 180 degrees and reflection coefficients for respective phases according to an embodiment of the disclosure.

FIG. 11A shows the phase shifts, and FIG. 11B shows the reflection coefficients, based on a 1 GHz bandwidth in the frequency range of 29.5 GHz to 30.5 GHz. According to simulation results, a phase delay in 10-degree increments from 0 degrees up to 180 degrees was implemented through physical adjustments of the internal structure of the waveguide. A minimum phase error of 0.2 degrees is maintained at a phase setting of 20 degrees, and a maximum phase error of 4.5 degrees is maintained at a phase setting of 180 degrees. The reflection coefficient remains stably at −25 dB or below in all phase shift ranges. Accordingly, the simulation results demonstrate that the waveguide of the disclosure is capable of stable signal transmission even if additional components are connected to the front and back ends of the phase shifter.

FIG. 12 is a block diagram schematically illustrating an example computing device that may be used to implement a method or apparatus according to the disclosure.

The computing device 120 may include some or all of memory 1200, processor 1220, storage 1240, input/output interface 1260, and communication interface 1280. The computing device 120 may be a stationary computing device such as a desktop computer or server, as well as a mobile computing device such as laptop computer or smart phone. The computing device 120 may also include any specialized hardware accelerator capable of processing operations on an artificial intelligence model in an efficient manner. For example, the computing device 120 may include a graphics processing unit (GPU), a tensor processing unit (TPU), or a neural processing unit (NPU).

The memory 1200 may store a program that causes the processor 1220 to perform a method or an operation according to various embodiments of the present disclosure. For example, the program may include a plurality of instructions executable by the processor 1220, and the aforementioned method or operation may be performed by executing the plurality of instructions by the processor 1220. The memory 1200 may be a single memory or a plurality of memories. In this case, information required to perform the method or operation according to various embodiments of the present disclosure may be stored in the single memory or may be divided and stored in the plurality of memories. When the memory 1200 is composed of a plurality of memories, the plurality of memories may be physically separated. The memory 1200 may include at least one of a volatile memory and a non-volatile memory. The volatile memory includes a static random access memory (SRAM), a dynamic random access memory (DRAM), or the like, and the non-volatile memory includes a flash memory and the like.

The processor 1220 may include at least one core capable of executing at least one instruction. The processor 1220 may execute instructions stored in the memory 1200. The processor 1220 may be a single processor or a plurality of processors.

The storage 1240 maintains the stored data even if power supplied to the computing device 120 is cut off. For example, the storage 1240 may include non-volatile memory and may also include storage media such as magnetic tape, optical disk, or magnetic disk. A program stored in the storage 1240 may be loaded into the memory 1200 before being executed by the processor 1220. The storage 1240 may store a file written in a program language, and a program generated by a compiler or the like from the file may be loaded into the memory 1200. The storage 1240 may store data to be processed by the processor 1220 and/or data processed by the processor 1220.

The input/output interface 1260 may provide an interface with an input device such as a keyboard or a mouse, and/or an output device such as a display device or a printer. A user may trigger execution of a program by the processor 1220 via the input device and/or confirm a processing result of the processor 1220 through the output device.

The communication interface 1280 may provide access to an external network. The computing device 120 may communicate with other devices via the communication interface 1280.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

As described above, according to an embodiment of the present disclosure, a cloud-based system for cultivating roughage may enable a grower to cultivate roughage conveniently by remotely controlling a cultivation apparatus.

According to an embodiment of the present disclosure, the cloud-based system for cultivating roughage may enable a grower to control a cultivation apparatus in a cost-effective manner.

The effects of embodiments of the present disclosure are not limited to the above-mentioned effects, and other effects not mentioned will be clearly understood by those skilled in the art from the above description.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

1. A waveguide comprising:
a housing comprising an internal accommodating space;
the waveguide inlet disposed on one side of the housing in the longitudinal direction; and
the waveguide outlet disposed on the other side of the housing in the longitudinal direction,
wherein the housing comprises:
a first plate disposed on one side in a height direction perpendicular to the longitudinal direction;
a second plate disposed on the other side in the height direction; and
a pair of third plates connecting the first plate and the second plate in the height direction and spaced apart from each other in a transverse direction perpendicular to the longitudinal direction and the height direction,
wherein a plurality of first pins disposed on the first plate and a plurality of second pins disposed on the second plate are spaced apart from each other in the height direction.

2. The waveguide of claim 1, wherein:
when viewed in the height direction, the plurality of first pins and the plurality of second pins do not overlap with each other.

3. The waveguide of claim 1, wherein:
when viewed from one side in the transverse direction, a cross-section of each of the plurality of first pins is configured such that one side in the longitudinal direction of the one end in the height direction is inclined toward the first plate.

4. The waveguide of claim 1, wherein:
when viewed from one side in the transverse direction, a cross-section of each of the plurality of second pins is configured such that one side in the longitudinal direction of the one end in the height direction is inclined toward the second plate.

5. The waveguide of claim 1, wherein:
a size of a cross-sectional area of the plurality of first pins is greater than a size of a cross-sectional area of the plurality of second pins.

6. The waveguide of claim 1, wherein:
the waveguide is symmetric about a horizontal axis bisecting the waveguide.

7. The waveguide of claim 1, wherein:
an opening of the waveguide inlet has a rectangular cross-section.

8. The waveguide of claim 1, wherein:
the plurality of first pins each have the same diameter.

9. The waveguide of claim 1, wherein:
the plurality of second pins each have the same diameter.

10. A method for designing a waveguide according to claim 1, performed by an electronic device comprising a processor and a memory, the method comprising:
adjusting a size of a plurality of first pins spaced apart from each other on a first plate disposed on one side in a height direction perpendicular to a longitudinal direction; and
adjusting a size of a plurality of second pins spaced apart from each other on a second plate disposed on the other side in the height direction.
